(19) United States
(12) Patent Application Publication
(10) Pub. No.: US 2017/0021401 A1
(43) Pub. Date: Jan. 26, 2017

(54) Method for Forming an End Part of a Tube, Respective Device for Performing the Method, Rolling Body, and Flange on an End Part of a Tube Formed with the Method

(71) Applicant: EFS Euro Forming Service GmbH, Bitburg (DE)

(72) Inventor: Manfred Klever, Bitburg (DE)

(21) Appl. No.: 15/300,837

(22) PCT Filed: Apr. 1, 2015
(86) PCT No.: PCT/EP2015/057218

§ 371 Date: Sep. 30, 2016

(30) Foreign Application Priority Data
Apr. 3, 2014 (DE) 10 2014 104 775.3

(51) Int. Cl. B21B 23/00; F16C 3/02; B60B 35/16; B21D 41/02; B21D 53/88

(52) U.S. Cl. CPC B21B 23/00; B21D 41/02; B21D 53/88; B60B 35/163; F16C 3/023; B60B 2310/224

(57) ABSTRACT

A method for forming an end part of a tube, such as a hollow shaft for use as a vehicle axle, is described. A rolling body having a rolling surface with an inwardly-curved contour rotates around a longitudinal axis with a first rotational speed and a second rotational speed. The rolling body and the tube rotate in the same direction. The longitudinal axis of the rolling body is arranged eccentrically to a longitudinal axis of the tube by a predetermined normal distance. The rolling body and the tube are brought into contact such that the rolling surface contacts the end part of the tube at a contact surface situated on an inner tube wall. The rolling body transfers a force to the inner tube wall by a relative movement between the rolling body and the tube such that the end part of the tube is formed radially outward.

### CROSS REFERENCE TO RELATED APPLICATION

The entire content of German Patent Application No. 10 2014 104 775.3 filed on Apr. 3, 2014 in which the priority right of the present patent application is claimed is herein incorporated by reference.

### TECHNICAL FIELD

The invention relates to a method for forming an end part of a tube, preferably of a hollow shaft suitable for use in a vehicle, especially of a hollow axle shaft, a respective device for performing the method, a rolling body, and a flange formed on an end part of a tube with the method.

### BACKGROUND

Conventionally, shafts, such as a drive shaft or an axle shaft, are used for transmitting the driving force from an internal combustion engine as a drive unit of a vehicle to drive wheels. Conventional axle shafts of an utility vehicle are built up of a solid material so that the axle shaft is a hollow shaft. An end part of the axle shaft is connected with a differential, and several assemblies, such as wheel carriers, a braking device, wheel bearings and the respective drive wheel, are attached to an opposed other end part. At the other end part, a flange is provided by upsetting so that the drive wheel can be mounted.

In view of the strict emission limit values specified by different authorities and commissions, such as the exhaust emission standard Euro-6, a weight reduction of the individual components integrated in the vehicle leads to a significant contribution for achieving these standards and objectives. Therefore, experiments have been carried out to form such axle shafts as hollow shafts as the bending load inside the axle shaft is lower compared to the outside, and therefore, the core of a solid shaft contributes less to the stability.

An axle hollow shaft is offered by U.S. Manufacturing Cooperation (USW), for example. However, with this axle hollow shaft, the flange required for the braking device and the drive wheel is welded on the axle hollow shaft. Providing a connecting welding seam at a shaft used in the drive train for transmitting the force flow from the internal combustion engine to the drive wheels causes numerous problems such as inclusions, a pore formation and blistering in the welding seam, an incomplete penetration and so forth. In practice, notwithstanding different test procedures for welding seams, these problems, defects or quality differences of the welding seams may occur. Therefore, in the case of high loads as provided during transmitting the driving force from the internal combustion engine to the drive wheels, the welding seam can undesirable crack.

Document U.S. Pat. No. 8,291,737 discloses a pressure device for bending up an end part of a metallic tube for air conditioning, refrigeration, sanitary and heating technology. According to this document, a mandrel is driven via a center shaft. The mandrel obliquely hits on the inner wall of the tube end on the side of the edge so that only a section of the tube end is machined in the circumferential direction. However, said pressure device is a mobile device which only enables machining of tubes with a small wall thickness as usual in the area of air conditioning, refrigeration, sanitary and heating technology.

Document U.S. Pat. No. 3,192,758 discloses an expanding device for forming apertures in a metal tube. An expansion of the tube is performed by a coaxial relative movement between the tube and the mandrel. However, in case of a relative movement of the mandrel and the tube, one disadvantage is that the surface of the mandrel entirely abuts on in the region of the end part of the tube. Therefore, as the entire circumference of the tube end is expanded, the expanding device requires a powerful feed mechanism.

Document U.S. Pat. No. 3,494,162 describes a device for forming an end section of a can, whereby a flange is formed at its end part. For machining the end part of the can, it is attached to a base via a holder. For machining the can end part, several processing heads are disclosed. One of the processing heads comprises three inward curved rollers which form the can end outward in order to form a flange. As the entire circumference of the can end is expanded, the expanding device requires a powerful feed mechanism.

Document U.S. Pat. No. 6,016,678 discloses a method for expanding and forming a flange at a boiler tube. The method relates to connecting boiler tubes with a tube bottom for use in steam boilers. To this end, a device with a plurality of expanding rollers held by a cage and radially driven by a rotating mandrel is used. Thereby, the diameter of the tube is radially increased with a coaxial relative movement between the tube and the expanding device. Further, the expanding device comprises a forming roller which is also radially driven by a mandrel, adapted such that a flange is formed at the tube end which is bent back. The flange serves for a stable connection of the tube with the tube bottom. The device comprises a complex structure and a lower efficiency due to the radial rolling rollers and the accompanying higher friction.

However, neither a method nor a suitable device for forming a flange for a tube, especially for a hollow shaft transmitting a driving force of an internal combustion engine, are disclosed by the prior art.

### SUMMARY

Therefore, it is the object of the present invention to provide a manufacturing method for a not welded flange at an end part of a tube, wherein the outer diameter of the flange is at least 1.5 times the outer diameter of the end part of the tube before forming the same, and the flange can be formed with a low forming force.

This object is achieved by a method for forming an end part of a tube, preferably of a hollow shaft suitable for use in a vehicle, especially a hollow axle shaft, with the features of claim 1.

According to the present invention, a method for forming an end part of a tube, preferably of a hollow shaft suitable for use in a vehicle, especially of a hollow axle shaft, is suggested. In this regard, a rolling body rotates around its longitudinal axis with a first rotational speed and is substantially cone shaped or truncated shaped. The rolling body has a rotationally symmetrical rolling surface around its longitudinal axis, wherein the contour of the rolling surface is at least sectionally curved inward. The tube rotates around its longitudinal axis with a second rotational speed. The rolling body and the tube rotate in the same direction. The longitudinal axis of the rolling body is arranged parallel to the longitudinal axis of the tube. The longitudinal axis of the rolling body is arranged eccentrically to the longitudinal axis of the tube by a predetermined normal distance. The rolling body and the tube are brought into contact such that the rolling surface of the rolling body contacts the tube in the end part region of the tube at a contact surface situated on an inner tube wall. The first rotational speed and the second rotational speed are set such that the absolute value of the difference calculated from a circumferential speed of the rolling body minus a circumferential speed of the tube at the contact surface in relation to the circumferential speed of the rolling body is in the range of 0 to 10%, preferably 0 to 5%, more preferably 0 to 2%. The rolling body transmits a force to the inner tube wall of the tube in the region of the contact surface by a relative movement between the rolling body and the tube such that the end part of the tube is formed radially outward.

According to the present invention, the contour of the rolling surface which is at least sectionally curved inward means that the contour is bent inward and curved inward, respectively, quasi convex. In this respect, the contour may be formed continuous or not continuous. In addition to one or more inward curved portions, the contour may have one or more rectilinear portions which provide the inward curved rolling surface together. The rectilinear portions may have a different slope and the inward curved portions may have a different curvature.

According to the present invention, “rolling surface” of the rolling body means the surface which is in contact with the inner wall of the end part of the tube during the forming process.

In the context of the present invention, “rolling body with a cone shape or a truncated shape” means a rolling body with a basic shape of a rotationally symmetrical cone or a rotationally symmetrical truncated cone. According to the present invention, this definition also includes rolling bodies which are different from the basic shape of a cone or a truncated cone in that the contour or generatrix or surface line of the rolling body may, notwithstanding the rectilinear shape, also be curved, that is curved inward or curved outward, or may be formed sectionally linear or curved, wherein the individual sections or portions may have different slopes and curvatures, respectively. With a sectional configuration of the contour or generatrix, the passages between the individual portions may be each continuous or not continuous. The above described deviation from the ideal basic shape of the cone or the truncated cone is particularly expressed by the expression “substantially cone shape or truncated shape”, however, it is also encompassed by the expression “with a cone shape or a truncated shape”.

The expression “rolling body with a cone shape or a truncated shape” or “rolling body which is substantially cone shaped or truncated shaped” according to the present invention also includes rolling bodies with the above described configuration, which comprise a circumferential collar in the region of the radial end portion or at the outer circumference of the same. In this respect, the contour of the rolling body passes into the contour of the collar continuously and seamlessly, respectively, in a radial outward direction. The collar preferably has a draft angle on its inner side.

“Forming surface” means the entire surface of the inner wall of the end part of the tube formed by the rolling surface of the rolling body.

The “contact surface” means the surface at which the rolling surface of the rolling body and the machining surface of the inner wall of the end part of the tube contact each other during the forming process. The contact surface changes depending on the progress of the forming process, and therefore, is a function of time. When contacting the rolling surface with the end part of the tube at the beginning of the forming process, the inner tube wall also includes the inner edge of the tube.

The relative movement between that rolling body and the tube required for the forming process can be achieved by a) moving the rolling body towards the tube, or b) moving the tube towards the rolling body, or c) moving the tube and the rolling body towards each other.

Due to the eccentric arrangement of the longitudinal axis of the rolling body to the longitudinal axis of the tube, the rolling surface does not entirely abut on the inner wall of the end part of the tube. Consequently, the contact surface does not extend over the entire circumference of the machining surface. Therefore, the pressure transferable to the contact surface and producible for forming is higher than in the case of an entire abutment of the rolling surface on the inner wall of the end part of the tube with constant driving force. This means that either tubes with a larger wall thickness and outer diameter, respectively, can be formed or a device with smaller dimensions, less energy consumption and smaller torque can be used. Hence, the power requirement of the device is only a fractional amount, i.e. 10%, compared to usual expansion devices, especially compared to the expansion device as disclosed in U.S. Pat. No. 3,192,758 as described above.

The configuration of the rolling body according to the present invention, especially the at least sectionally inward curved contour of the rolling surface, enables in an advantageous manner that the material of the end part of the tube flows along the contour of the rolling surface radially outward during the forming process.

By rotating the tube and the rolling body in the same direction with substantially the same circumferential speeds, setting off or slipping off of the rotating body from the tube, namely at the contact surface, or vice versa is effectively prevented. Hence, an unnecessary friction is prevented and the tube is not damaged at its inner tube wall.

According to said method, it is possible for the first time to manufacture a flange at a tube, preferably a hollow shaft suitable for use in a vehicle, especially a hollow axle shaft, without providing welding seams, wherein the dimensions of the flange are set such that a drive wheel can be attached thereto. The hollow shaft suitable for use in a vehicle can be a propeller shaft, an axle shaft, a side shaft, a connection shaft, a shaft used with a steering unit or by superchargers and so forth.

Further configurations of the method according to the present invention correspond to the subject-matters of the dependent claims.

The transmittable force to the inner wall of the tube may be limited to not more than 500 kN (50 t), preferably to a range between 1 (0.1 t) and 400 kN (40 t), preferably to a range between 5 (0.5 t) and 300 kN (30 t), more preferably to a range between 10 (1 t) and 250 kN (25 t). As the rolling surface only abuts at the contact surface on the inner wall of the end part of the tube due to the eccentricity of the longitudinal axis of the rolling body to the longitudinal axis of the tube, only a fractional amount of the force is required for the forming process, whereby the method is especially suitable for relative small manufacturing machines.

With a projection of the contact surface and a projection of the rolling surface on a plane perpendicular to the longitudinal axis of the rolling body, the projection of the contact surface may be entirely enclosed in a circle sector of the projection of the rolling surface. The circle sector may comprise an angle at center of not more than 240°, preferably of not more than 180°, preferably of not more than 150°, more preferably of not more than 120°. The circle sector may comprise an angle at center of not more than 210°, preferably of not more than 170°, preferably of not more than 130°, more preferably of not more than 105°. The angle at center is smaller and the pressure acting on the contact surface is higher, the smaller the contact surface is set.

Starting from a first contact with the inner side of a circumferential collar on an outer circumference of the rolling body, the material of the end part of the tube may abut or be supported on the inner side of the collar over a period of time during the forming process. With this configuration, a sharp tapering of the material at a formed end part of the tube can be prevented. Especially, it is desirable for a following pressure forming process that the flange formed by the forming process has a constant thickness or even has a larger thickness compared to the original thickness at an edge portion of the formed tube.

The first rotational speed of the rolling body may be between 300 to 1500 rpm, preferably between 450 to 1100 rpm, more preferably between 600 to 700 rpm. The second rotational speed of the tube may be between 300 to 1500 rpm, preferably between 450 to 1100 rpm, more preferably between 600 to 700 rpm. Especially in this area, the method for forming an end part of a tube is advantageously performed.

At least during a time when the rolling body is in contact with an inner wall of the end part of the tube, the end part of the tube may have a temperature between 700 to 1300° C., preferably between 1000 to 1250° C., more preferably between 1150 to 1200° C. At least during a time when the rolling body is in contact with an inner wall of the end part of the tube, the rolling body may have a temperature between 100 to 250° C., preferably between 140 to 210° C., more preferably between 150 to 200° C. The rolling body and/or the end part of the tube can be inductive heated. In this temperature region of the tube and the rolling body, the method for forming an end part of a tube is advantageously performed.

In addition to a conventionally manufactured tube with a constant outer diameter and/or a constant wall thickness, according to the present invention, a tube which is warm-upsetted before the forming process performed with the rolling body may be used.

After the forming process by the rolling body, the expanded end part of the tube may be further formed by at least one pressure forming process. Pressure forming processes are, for example, compression molding, die forging, cold die bobbing, upsetting or heading and so on.

According to another aspect of the present invention, a flange according to claim 11 is suggested. The flange according to the present invention is manufactured at an end part of a tube, preferably of a hollow shaft suitable for use in a vehicle, especially of a hollow axle shaft, according to the method as described above. With this method, forming a flange at a tube, preferably at a hollow shaft suitable for use in a vehicle, especially at a hollow axle shaft, without providing welding seams is possible for the first time, wherein a drive wheel is attached to the flange via several assemblies.

A ratio between an outer diameter of the formed end part of the tube to an outer diameter of a not formed portion of the tube may exceed 1.5:1, preferably exceed 2:1, preferably exceed 3:1, more preferably exceed 4:1. However, a ratio between an outer diameter of the formed end part of the tube to an outer diameter of a not formed portion of the tube may also exceed 1.5:1, preferably exceed 1.8:1, preferably exceed 2.5:1, more preferably exceed 3.5:1. In order to achieve such a ratio, the rolling surface has to comprise a respective dimension in the radial direction.

The formed end part of the tube may comprise at least one portion with a wall thickness greater than a wall thickness of a not formed portion of the tube. Such a configuration of the flange is especially important at a following pressure forming process to perform a following pressure forming process for shaping the final flange contour.

According to another aspect of the present invention pursuant to claim 14, a device for forming an end part of a tube, preferably of a hollow shaft suitable for use in a vehicle, especially of a hollow axle shaft, preferably suitable for performing the above described method, is suggested. The device comprises a rolling body with a longitudinal axis. The rolling body is substantially cone shaped or truncated shaped and has a rotationally symmetrical rolling surface around its longitudinal axis, wherein the contour of the rolling surface is at least sectionally curved inward. Further, the device comprises a rotatable means for receiving and attaching the tube. The longitudinal axis of the rolling body is arranged eccentrically to a longitudinal axis of the tube by a predetermined normal distance, and parallel to the longitudinal axis of the tube, when the tube is attached to the means. Here, the same effects according to the present invention are achieved as with the above described method.

The ratio of the normal distance to an outer diameter of the end part of the tube before said forming process may be in a range of 1:60 to 1:2, preferably 1:30 to 1:3, more preferably 1:6 to 1:3. In case of a tube with an outer diameter of 60 mm, the normal distance may be between 1 and 40 mm, preferably between 5 and 30 mm, more preferably between 10 to 20 mm.

The rolling body can be driven axially around its longitudinal axis preferably by means of a drive shaft. For forming an end part of the tube, the rolling body can be driven during the axial driving by means of its stem or by mounting on a drive shaft of a device.

According to another aspect of the present invention pursuant to claim 17, a rolling body for forming an end part of a tube, preferably of a hollow shaft suitable for use in a vehicle, especially of a hollow axle shaft, preferably suitable for performing the above described method, is suggested. The rolling body is substantially cone shaped or truncated shaped and has a rotationally symmetrical rolling surface around its longitudinal axis. The contour of the rolling surface is at least sectionally curved inward. A circumferential collar is arranged at an outer circumference of the rolling body. The inward curved or inward bent, quasi convex, contour of the rolling surface passes radially outward into the collar without a seam. The collar preferably has a draft angle larger than 0°, preferably larger than 1°, more preferably larger than 5°. The collar may be integrally formed with the rolling body or may be attached to the rolling body in another way, such as welding, for example. The rolling body according to the present invention provides the same effects as the above described method.

A tangent to a radially outward edge portion of the rolling surface and the longitudinal axis may define an angle larger than 70 to 105°, preferably larger than 75 to 100°, more preferably larger than 80 to 95°. Viewed from a top and a flat portion, respectively, towards a base it is the angle between the longitudinal axis and the tangent which is spanned averted from the top. Therefore, the material of the end part of the tube flows advantageous along the contour of the rolling surface radially outward according to the above angle specification, so that a following pressure forming process for forming the final flange contour can be performed.

According to another aspect of the present invention, a rolling body for forming an end part of a tube, preferably of a hollow shaft suitable for use in a vehicle, especially of a hollow axle shaft, preferably suitable for performing the above described method, is suggested. The rolling body comprises a rolling surface and a longitudinal axis, wherein a tangent on any point of the rolling surface and the longitudinal axis define an angle larger than 0 to 120°, preferably larger than 0 to 105°, more preferably larger than 0 to 90°, wherein in a section of the rolling surface, the angle is larger than 45°, preferably larger than 60°, more preferably 70° or larger, wherein the section includes an edge region of the rolling surface, and wherein the angle increases at least sectionally with an increasing normal distance of the point from the longitudinal axis. Viewed from a top and a flat portion, respectively, towards a base it is the angle between the longitudinal axis and the tangent which is spanned averted from the top.

According to another aspect of the present invention, a rolling body for forming an end part of a tube, preferably of a hollow shaft suitable for use in a vehicle, especially of a hollow axle shaft, preferably suitable for performing the above described method, is suggested. The rolling body comprises a longitudinal axis and a rolling surface with a contour, wherein the contour of the rolling surface is formed such that a tube wall of an end part of the tube can be formed in a range between 70° and 120° to the longitudinal axis of the rolling body during the forming process.

### BRIEF DESCRIPTION OF THE DRAWINGS

The above described features and functions of the present invention as well as further aspects and features are further explained in the following with a detailed description of preferred embodiments with reference to the attached figures.

FIGS. 1a to 1c are sectional views of rolling bodies according to the present invention;

FIG. 2 is a sectional view of a device for forming an end part of a tube according to the present invention;

FIGS. 3 to 5 are sectional views illustrating different points in time of a method for forming an end part of a tube;

FIGS. 6 and 7 are projections of a contact surface and a rolling surface on one plane; and

FIGS. 8 and 9 illustrate a device for performing a pressure forming process with a punch and a die.

### DETAILED DESCRIPTION OF THE EMBODIMENTS

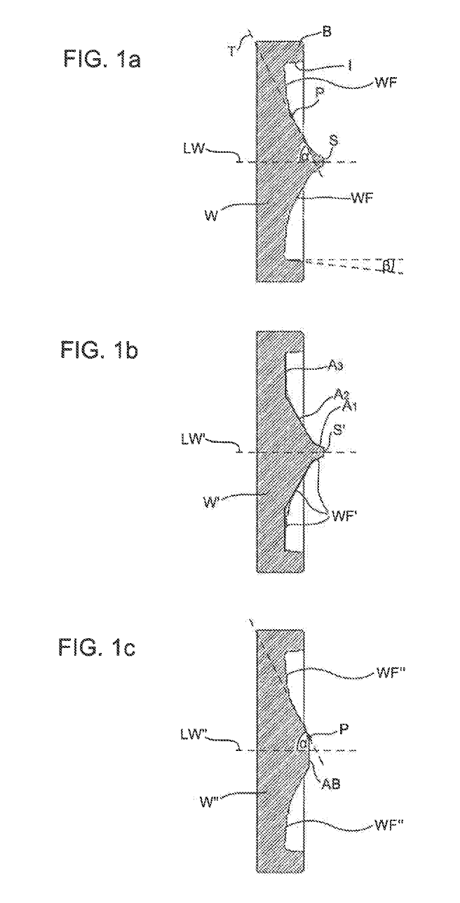

FIG. 1a illustrates a sectional view of a rolling body W according to the invention pursuant to an embodiment of a rolling body. The rolling body W is formed rotationally symmetrical around its longitudinal axis LW with a rolling surface WF for forming, in particular rolling, a workpiece. The rolling surface WF is formed with an inward curved shape and extends from a mandrel-like top S lying on the longitudinal axis LW in an inward curved manner radially to the outside. A tangent T located on an arbitrary point P of the rolling surface WF shown in FIG. 1 and the longitudinal axis LW define an angle α. Due to the inward curved configuration of the rolling surface LW, the angle α increases from the mandrel-like top S radially outward, such that arbitrary points P of the rolling surface WF include an angle α larger than 0° to about 85°. Viewed from a top S towards a base BA, it is the angle α between the longitudinal axis LW and the tangent, which is spanned averted from the top S. A circumferential collar B on an outer circumference of the rolling body W is provided at an edge portion of the rolling surface WF, where the point P has the largest angle α. The collar B is formed integrally with the rolling body W and comprises an inner side I with a draft angle β of 5°. The rolling body W comprises a not shown stem for receiving in a device.

FIG. 1b is a sectional view of another rolling body W′ according to the present invention. The rolling body W′ with a longitudinal axis LW′ has a different rolling surface WF′ compared to the rolling body W according to FIG. 1a. The rolling surface WF′ comprises three sections A₁, A₂, A₃ with a different slope, in which the tangents T located on arbitrary points P in one respective section A₁, A₂, A₃ of the rolling surface WF′ defines the same angle α with the longitudinal axis LW′. The angle α of the tangents located on the points P in section A₁ of the rolling surface WF′ is 45°, the angle α of the tangents located on the points P in section A₂ of the rolling surface WF′ is 70°, and the angle α of the tangents located on the points P in section A₃ of the rolling surface WF′ is 90°. Viewed from a top S′ towards a base BA′, it is the angle α between the longitudinal axis LW′ and the tangent, which is spanned averted from the top S′.

FIG. 1c is a sectional view of another rolling body W″ according to the present invention. The rolling body W″ with a longitudinal axis LW″ does not comprise a mandrel-like top S compared to the rolling body W according to FIG. 1a but a flattening AB so that the rolling body has a truncated shape. The flattening AB is not for forming an end part of a tube and does not constitute a part of the rolling surface WF″. A passage between the flattening AB to the rolling surface WF″ is formed such that the angle α of a tangent located at a point P to the longitudinal axis LW″ of the rolling surface WF″ is 45°. Viewed from a flattening AB towards a base BA″, it is the angle α between the longitudinal axis LW″ and the tangent, which is spanned averted from the flattening AB.

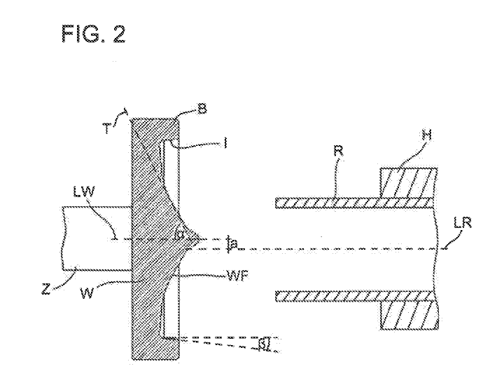

FIG. 2 is a sectional view of a device according to the present invention for forming an end part of a tube R pursuant to an embodiment of such a device. With the device for forming an end part of a tube R, the rolling body W according to FIG. 1a is used.

The rolling body W which is attached to a drive shaft via a stem Z is rotationally driven by a first drive motor, not shown, with a first rotational speed D₁. The drive shaft is moveable in the axial direction together with the rolling body W by means of a not shown feed motor, and for an accurate positioning transverse to the axial direction via a slide system consisting of several slides.

The tube R is attached in a rotatable means H for receiving and attaching the tube R. The tube R which is attached in the means H is rotationally driven by another not shown drive motor with a second rotational speed D₂. For an accurate positioning transverse to the axial direction, the rotatable means H also has a not shown slide system consisting of a plurality of slides.

The rolling body W with its longitudinal axis LW and the tube R with its longitudinal axis LR are arranged parallel and eccentric to each other with a normal distance a in FIG. 2.

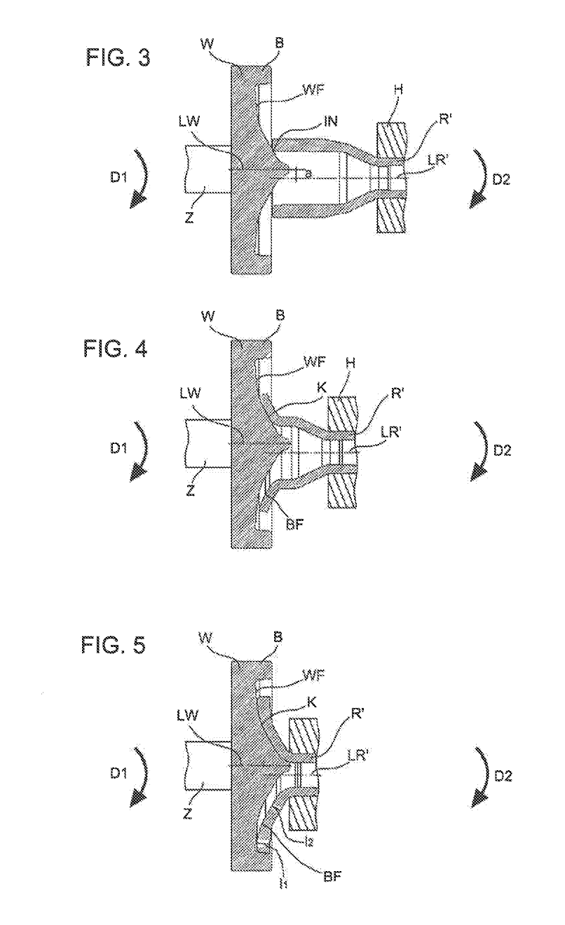

FIGS. 3 to 5 are sectional views showing different points in time and snap shots, respectively, of an method for forming an end part of a warm-upsetted tube R′ according to the present invention. The warm-upsetted tube R′ is made of steel and has an outer diameter of 115 mm and a wall thickness 1 of 18 mm. The normal distance a between the longitudinal axis LW of the rolling body W and the longitudinal axis LR of the warm-upsetted tube R′ is 15 mm. The first rotational speed D₁ of the rolling body W and the second rotational speed D₂ of the warm-upsetted tube R′ are set to 600 rpm during the whole forming process so that a circumferential speed U₁ of the rolling body W and a circumferential speed U₂ of the warm-upsetted tube R′ are the same. The warm-upsetted tube R′ is inductive heated up to 1150° C. and the rolling body W is inductive heated up to 150° C. for forming.

The warm-upsetted tube R′ with a first rotational speed D₁ is moved in the axial direction to the rolling surface WF of the rolling body W with a second rotational speed D₂. At the beginning of the forming by means of the rolling body W, the end part of the warm-upsetted tube R′ to be formed and the rolling surface WF contact each other at an inner edge IN of the end part of the warm-upsetted tube R′ so that in case of a three-dimensional view, a contact surface KF corresponds to a line running in the circumferential direction, and in case of a two-dimensional view, as shown in FIG. 3, corresponds to a point.

With a continuous movement of the warm-upsetted tube R′ in the axial direction towards the rolling surface WF of the rolling body W, as shown in FIG. 4, the material of the end part of the tube R′ is formed radial outward continuously along the contour of the rolling surface WF, that is, the material flows radial outward. Therefore, the contact surface KF at which the rolling surface WF of the rolling body W is in contact with a contacting machining surface BF of an inner tube wall RI of the warm-upsetted tube R′ increases, and in case of a three-dimensional view, is identifiable as a surface, and in case of a two-dimensional view, as illustrated in FIG. 4, as a line. The machining surface BF forms the entire surface to be machined during the forming, that is, an expanded inner side of the warm-upsetted tube R′.

At the end of the forming process by means of the rolling body W, as shown in FIG. 5, the contact surface KF is maximal. Already shortly before this point in time, the end part of the warm-upsetted tube R′ abuts against the inner side I of the circumferential collar B on the outer circumference of the rolling body W, so that a thickening forms at the end part of the tube R′. Near the end face, the formed end part has a thickness l₁ greater than a thickness l₂ of a not formed region of the warm-upsetted tube R′ and/or of a formed region of the tube R′ lying further at the center of the warm-upsetted tube R′. The draft angle θ enables a separation of the warm-upsetted tube R′ from the rolling body W in an opposite axial direction or vice versa.

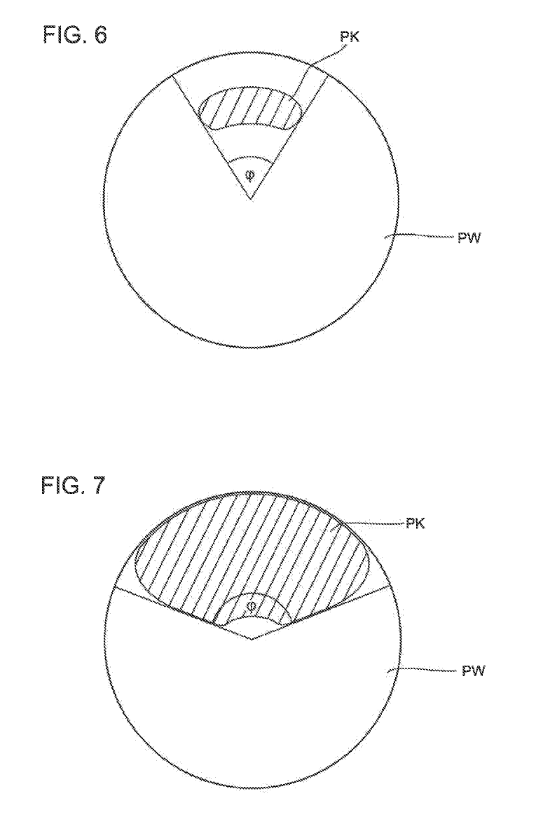

FIGS. 6 and 7 are projections of the contact surface KF and the rolling surface WF on a plane lying in the drawing layer at different points in time of the forming process. A hatched projection PK of the contact surface KF and a projection PW of the rolling surface WF are illustrated on a plane perpendicular to the longitudinal axis LW, wherein the projection PK of the contact surface KF is entirely enclosed in a circle sector of the projection PW of the rolling surface WF. The circle sector has an angle φ at center of 65° in FIG. 6, and in FIG. 7, the circle sector has an angle φ at center of 120°. The projection PK of the contact surface KF illustrated in FIG. 6 approximately corresponds to the contact surface KF shown in FIG. 4. The projection PK of the contact surface KF illustrated in FIG. 7 approximately corresponds to the contact surface KF shown in FIG. 5.

As the hatched projection PK of the contact surface KF only takes a circle sector of the projection PW of the rolling surface WF, that is, does not extend around the entire circumference of the warm-upsetted tube R′, less feed force (maximal 250 kN and 25 t, respectively) is required for forming the end part of the warm-upsetted tube R′. Further, at the beginning of the forming process, the highest pressure is applied to the end part of the warm-upsetted tube R′ by the rolling body W with a constant feed force over the entire forming process as the contact surface is smallest at this point in time.

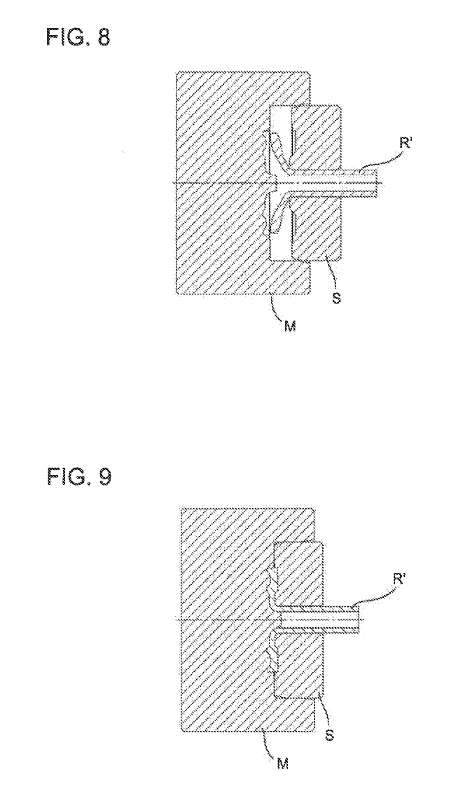

FIGS. 8 and 9 illustrate a device for performing a pressure forming process with a punch S and a die M. The end part of the warm-upsetted tube R′ is inserted as a blank into the die M and obtains its final shape by an interaction of the punch S and the die M, so that a flange is formed at a warm-upsetted tube R′.

In addition to the explained embodiments, the present invention also allows further configuration approaches.

The rolling body W′ comprises three sections or portions with a different slope. However, the rolling surface of a rolling body according to the present invention may also be formed such that it comprises one, two, four, five or any number of rectilinear sections and/or one, two, three or any number of inward curved sections.

The above described rolling bodies comprise a not shown stem for receiving in a device; however, the rolling bodies may also be formed as shell tools.

The rolling body with the device for forming an end part of a tube R is not limited to the rolling body illustrated in FIGS. 2 to 5 but using other rolling bodies, such as the rolling body W′ according to FIG. 1b, or the rolling body W″ according to FIG. 1c et seq. is possible.

Although a warm-upsetted tube R′ with a wall thickness 1 of 18 mm is formed above, according to the invention, also tubes with a wall thickness between 5 mm to 100 mm, preferably between 10 mm to 80 mm, more preferably between 15 mm and 70 mm, can be formed.

Although the warm-upsetted tube R′ machined in the embodiment is made of steel, also tubes made of aluminum or an alloy of steel and/or aluminum can be formed.

Although not shown in FIGS. 8 and 9, openings, such as bores, threaded holes et seq., may be provided in the flange at the warm-upsetted tube R′.

1. A method for forming an end part of a tube, preferably of a hollow shaft suitable for use in a vehicle, especially a hollow axle shaft, wherein:
a rolling body rotates around its longitudinal axis with a first rotational speed,
wherein the rolling body is substantially cone shaped or truncated shaped,
wherein the rolling body has a rotationally symmetrical rolling surface around its longitudinal axis, and
wherein the contour of the rolling surface is at least sectionally curved inward,
the tube rotates around its longitudinal axis with a second rotational speed,
the rolling body and the tube rotate in the same direction,
the longitudinal axis of the rolling body is arranged parallel to the longitudinal axis of the tube,
the longitudinal axis of the rolling body is arranged eccentrically to the longitudinal axis of the tube by a predetermined normal distance,
the rolling body and the tube are brought into contact such that the rolling surface of the rolling body contacts the tube in the end part region of the tube at a contact surface situated on an inner tube wall,
wherein the first rotational speed and the second rotational speed are set such that the absolute value of the difference calculated from a circumferential speed of the rolling body minus a circumferential speed of the tube at the contact surface in relation to the circumferential speed of the rolling body is in the range of 0 to 10%, preferably 0 to 5%, more preferably 0 to 2%, and
wherein the rolling body transmits a force to the inner tube wall of the tube in the region of the contact surface by a relative movement between the rolling body and the tube such that the end part of the tube is formed radially outward.

2. The method according to claim 1, characterized in that the force is not more than 500 kN, preferably in a range between 1 and 400 kN, preferably in a range between 5 and 300 kN, more preferably in a range between 10 and 250 kN.

3. The method according to claim 1, wherein when a projection of the contact surface and a projection of the rolling surface are on a plane perpendicular to the longitudinal axis of the rolling body, the projection of the contact surface is entirely enclosed in a circle sector of the projection of the rolling surface, and
wherein the circle sector comprises an angle at center of not more than 240°, preferably of not more than 180°, preferably of not more than 150°, more preferably of not more than 120°.

4. The method according to claim 1, wherein the material of the end part of the tube abuts on an inner side of a circumferential collar on an outer circumference of the rolling body over a period of time during the forming from a first contact with the inner side.

5. The method according to claim 1, wherein the first rotational speed of the rolling body is between 300 to 1500 rpm, preferably between 450 to 1100 rpm, more preferably between 600 to 700 rpm.

6. The method according to claim 1, wherein the second rotational speed of the tube is between 300 to 1500 rpm, preferably between 450 to 1100 rpm, more preferably between 600 to 700 rpm.

7. The method according to claim 1, wherein the end part of the tube has a temperature between 700 to 1300° C., preferably between 1000 to 1250° C., more preferably between 1150 to 1200° C., at least during a time when the rolling body is in contact with an inner wall of the end part of the tube.

8. The method according to claim 1, wherein the rolling body has a temperature between 100 to 250° C., preferably between 140 to 210° C., more preferably between 150 to 200° C., at least during a time when the rolling body is in contact with an inner wall of the end part of the tube.

9. The method according to claim 1, wherein the tube is warm-upsetted before being formed by means of the rolling body.

10. The method according to claim 1, wherein after the forming by means of the rolling body, the upsetted end part of the tube is further formed by means of at least one pressure forming process.

11. A flange on an end part of a tube, preferably of a hollow shaft suitable for use in a vehicle, especially a hollow axle shaft, manufactured using the method according to claim 1.

12. The flange according to claim 11, wherein a ratio between an outer diameter of the formed end part of the tube to an outer diameter of a not formed portion of the tube exceeds 1.5:1, preferably exceeds 2:1, preferably exceeds 3:1, and more preferably exceeds 4:1.

13. The flange according to claim 11, wherein the formed end part of the tube has at least one portion with a wall thickness which is greater than a wall thickness of a not formed portion of the tube.

14. A device for forming an end part of a tube, preferably of a hollow shaft suitable for use in a vehicle, especially a hollow axle shaft, preferably suitable for performing the method according to claim 1, wherein the device comprises:
a rolling body with a longitudinal axis, wherein the rolling body is substantially cone shaped or truncated shaped, wherein the rolling body has a rotationally symmetrical rolling surface around its longitudinal axis, and wherein the contour of the rolling surface is at least sectionally curved inward; and
a rotatable means for receiving and attaching the tube, wherein the longitudinal axis of the rolling body is arranged eccentrically to a longitudinal axis of the tube by a predetermined normal distance, and parallel to the longitudinal axis of the tube, when the tube is attached to the means.

15. The device according to claim 14, wherein the ratio of the normal distance to an outer diameter of the end part of the tube before said forming is in a range of 1:60 to 1:2, preferably 1:30 to 1:3, and more preferably 1:6 to 1:3.

16. The device according to claim 14, wherein the rolling body can be driven axially around its longitudinal axis, preferably by means of a drive shaft.

17. A rolling body for forming an end part of a tube, preferably of a hollow shaft suitable for use in a vehicle, especially a hollow axle shaft, preferably suitable for performing the method according to claim 1,
wherein the rolling body is substantially cone shaped or truncated shaped,
wherein the rolling body has a rotationally symmetrical rolling surface around its longitudinal axis,
wherein the contour of the rolling surface is at least sectionally curved inward,
wherein a circumferential collar is arranged at an outer circumference of the rolling body, and
wherein the collar has a draft angle larger than 0°, preferably larger than 1°, and more preferably larger than 5°.

18. The rolling body according to claim 17, wherein a tangent to a radially outward edge portion of the rolling surface and the longitudinal axis define an angle larger than 70 to 105°, preferably larger than 75 to 100°, and more preferably larger than 80 to 95°.
